(19) United States
(12) Patent Application Publication
(10) Pub. No.: US 2026/0097242 A1
(43) Pub. Date: Apr. 9, 2026

(54) SET OF ESCAPING DEVICES FOR ESCAPING FROM HIGH-RISE BUILDINGS OR HIGH-LEVEL LOCATIONS

(71) Applicants: Tian Li David Liu, Bloomington, CA (US); Guo Feng Liu, An San Shi (CN)

(72) Inventors: Tian Li David Liu, Bloomington, CA (US); Guo Feng Liu, An San Shi (CN)

(21) Appl. No.: 18/907,472

(22) Filed: Oct. 5, 2024

(51) Int. Cl. A62B 1/10; A62B 1/16; A62B 1/18

(52) U.S. Cl. CPC A62B 1/10; A62B 1/16; A62B 1/18

(57) ABSTRACT

The present invention application provides a set of escaping devices for self-rescue, mutual rescue, and help-calling from high buildings or places in danger or emergencies. The escaping devices comprise at least one first and multiple sets of second devices, which can meet the needs of people from one or more families, one or more classes of teachers and students, and one or more office personnel. All devices have three ways to regulate the descent speed. The escapees can effectively and orderly leave the dangerous environment through help of the intercom answering machine and quickly count the survivors. If there are trapped people, the rescue center can activate the wireless calling system to detect and locate the trapped people and carry out rapid rescue.

### CROSS-REFERENCE TO RELATED APPLICATIONS

This application is a continuation in part of the P.R. China patent application Ser. No. CN202410443467.7, filed Apr. 12, 2024, is incorporated herein fully by reference.

### FIELD OF INVENTION

The present invention relates to a set of devices for escaping from high-rise buildings or places in case of fire, earthquake, amusement facilities, high mountains, and other special needs, and more particularly to a set of simple and convenient escape devices for self-rescue, mutual rescue, calling for help, and positioning from high-rise buildings or high places.

### BACKGROUND

High-rise buildings are a symbol of modern urban business and home life. Various high-altitude recreational and aerial cableway service facilities are popular recreational and travel tools. Mountain climbing is also becoming a popular outdoor sport. However, once an earthquake, fire, or other natural disaster occurs, how to escape from high-rise buildings and high places in a timely, effective, and orderly manner and post-disaster rescue is an issue that cannot ignored. In response to a high-rise escape under critical conditions, Stone et al. disclosed “a personal escape device” (U.S. Pat. No. 8,499,890 B2) on Jul. 1, 2010. The device consists of a complex gearbox and power system. Huang published a “Descent rescue device with double brake and back and forth controlled” (US 2015/0352380 A1) on Dec. 10, 2015. U.S. Pat. No. 5,842,542 uses a manual braking system, such as a rope windlass system, to slow the passage of a rope as the person descends. Yin Pengfei and Sun Jiayu disclosed “A high-rise self-rescue escape device” (CN 205287283 U) on Jun. 8, 2016, which is composed of multiple gears, main shafts, and secondary shafts; Huang Haisong et al. disclosed “A rope deceleration and recovery structure of a high-rise circulating escape device” (CN 105688342 B) on Jun. 22, 2016, which is composed of multiple structures that allow the life rope to be recycled; Xiao Yulong disclosed a “free fall high-rise escape device” (CN 109865211 B) on Dec. 1, 2017, which is composed of escape protective gear and a drive mechanism. On Nov. 19, 2017, Ge Xiaofei et al. published “An Indoor Autonomous Positioning and Status Monitoring System and Method” (CN 107339985 A), which combines multiple sensors to achieve personnel positioning and command.

However, prior art and commercial products related to escape are generally complicated to operate and can only be used skillfully with training; almost all escape devices cannot control the landing speed in real-time, which may cause the escapees injury during the escape process. The rescue efficiency is poor, especially in crowded places such as large commercial office buildings or apartments, single-person disposable escape equipment will cause the escapees to entangle and collide in the air, thereby causing severe casualties. The existing technologies and equipment also lack the ability and means to guide the escapees to escape from dangerous environments in an orderly and effective manner. They cannot accurately count the survivors in real time and effectively and precisely locate the trapped people for rapid and effective rescue.

### SUMMARY OF THE INVENTION

The present invention has designed a set of simple and convenient devices for self-rescue, mutual rescue, and calling for rescue for people of different ages, such as families, schools, and business or public office buildings, to escape from a high building or place. The use of escape devices is simple. While escaping from dangerous situations, a person can regulate the decline speed in real time in three ways. The ground personnel and escape personnel can communicate and coordinate with each other. The intercom allows for the calculation of survivors. Rescuers can also locate each trapped escape device and search for trapped persons further.

The present invention provides the first escape device for the first person to escape from high-rise buildings or places when disasters occur. While the first escapee uses the first escape device to escape, an escape passage, cable, is also established for all other escapees. All other escapees can use the second escape device to escape along the cable established by the first escapee. The first escape device comprises an upper, lower, front, and rear case with safety belts. The escape device includes a pair of spring regulators that control the descent speed by regulating the first escapee's weight and inertial mass. The two-hand brakes control the wire rope release speed or completely stop the wire rope release as needed. The speed control of the first escape device also includes a pair of protective gloves made of high-strength friction material. Escapees can use gloves to control the escape cable's descent speed and release speed by holding the cable in case of an abnormal function of the pair of spring regulators or/or hand brakes. With an automatic positioning function, the walkie-talkie answering machine provides critical functions for coordinating and cooperating among all escapees. A safety helmet with a lighting lamp and numerous warning lamps can keep the descent distance between the escapees and prevent any falling materials from injuring escaping people. The shoulder and leg strips are simple but efficient means of keeping the escape device and the first escapee together and ensuring the escape can keep the escape device together.

The plurality of second escape devices can help one or more family members, teachers, and students of one or more classes or business or public office personnel. It allows them to use the escape cable established by the first escapee to evacuate from the fire scene or the disaster-affected high-rise building in an orderly manner. The second escape device is almost the same as the upper part of the first escape device, including a pair of spring regulators and two hand brakes that regulate the descent speed by controlling the gravity and inertial mass of the escapee and the escape device. Each second escape device also has a pair of fireproof gloves made of high-strength friction material, which controls the descent speed by holding the escape cable in the event of abnormal function of the regulator and the hand brake. The safety helmet with a lighting lamp and warning lights in each second escape device provides extra protection for each escapee from injury caused by falling materials. It helps all escapees keep a safe distance from each other. The shoulder and leg strips are simple but efficient means of maintaining the escape device and the second escapee together and ensuring the escapee can keep the escape device together. The second escape devices allow people to escape from a high-rise or high location if there is a pre-existing or available cable, rope, tube, or similar structure. This unique characteristic of the second escape device may become a necessary configuration for all buildings and high locations.

The intercom answering machine with an automatic positioning function installed on the first and second escape devices has manual and wireless wake-up answering functions. If trapped in a building or a high place, the trapped person can call for help through the intercom answering machine and inform the trapped person of the trapped state, location, and whether the person is injured. In the case the escape device equipment is separated from the trapped person, the life-saving center can open an emergency rescue wireless search channel and activate the intercom answering machine switch through radio waves so that the trapped person can call for help without approaching the intercom answering machine; if the trapped person is in a state of difficulty in speaking due to injury, the answering intercom can send back the trapped person's breathing, heartbeat and other vital signs to the search and rescue center through the radio reception and signal amplification functions, thereby accelerating post-disaster rescue. The intercom mobile unit's manual switch, voice-activated switch, and wireless start switch can help the trapped persons communicate with the rescuers.

Compared with the prior art and commercial escape products, the present invention provides a set of escape devices for members from one or more families, teachers and students from one or more classes, and all other people to escape from high buildings or high locations once fire or earthquake or other nature dilaters occurred. To overcome gravity acceleration and further control the descent speed, the weight of the escapee and the equipment is regulated by the tension of the spring, thereby effectively controlling the descent acceleration to ensure the life safety of the escapee. Hand breaks provide an extra means to regulate and control the descent speed of the escapee and enable it to entirely stop as required during escaping and avoid various dangerous situations for life safety. All escapees can use the intercom answering machine for mutual observation, coordination, and assistance from different angles during the escape process, external calls for help when trapped, and post-disaster search and rescue. The unique advantages of the present invention are that the escape device has a simple structure, is easy to manufacture, and is safe to use; in particular, the exteriors of the important functional parts of the first and second escape devices are designed in the shape of a bicycle handlebar, a handlebar of the handbrake, and a backpack, which are well-known to everyone, so that all personnel can know at a glance how to use the device, making it a multi-purpose device suitable for escape and rescue in high buildings, heights, and mountains for both young and old.

### DESCRIPTION OF THE DRAWING

FIG. 1 is a perspective view of a set of devices used for escaping from high-rise buildings or high-level locations;

FIG. 2 shows an exploded view of the first escape device, and FIG. 2A is an enlarged view of the digital mark ring;

FIG. 3 is a schematic diagram of the synthesis of the first escape device;

FIG. 4 is a front view of the first escape device;

FIG. 5 is a schematic diagram of a helmet;

FIG. 6 is a schematic diagram of a pair of gloves;

FIG. 7 shows an exploded view of the second escape device and FIG. 7A is an enlarged view of the digital mark ring;

FIG. 8 is a schematic diagram of the synthesis of the second escape device.

FIG. 9 is a front view of the second escape device;

FIG. 10 is a schematic diagram of a helmet;

FIG. 11 is a schematic diagram of a pair of gloves.

### DETAILED DESCRIPTION OF PREFERRED EMBODIMENTS

The technical solutions of the present invention are now described and introduced in conjunction with the accompanying drawings to highlight its features and advantages. Although all the drawings and descriptions focus on the typical embodiments, device structures, and application methods of the present invention, this should not be regarded as or constitute a limitation on the scope of the present invention.

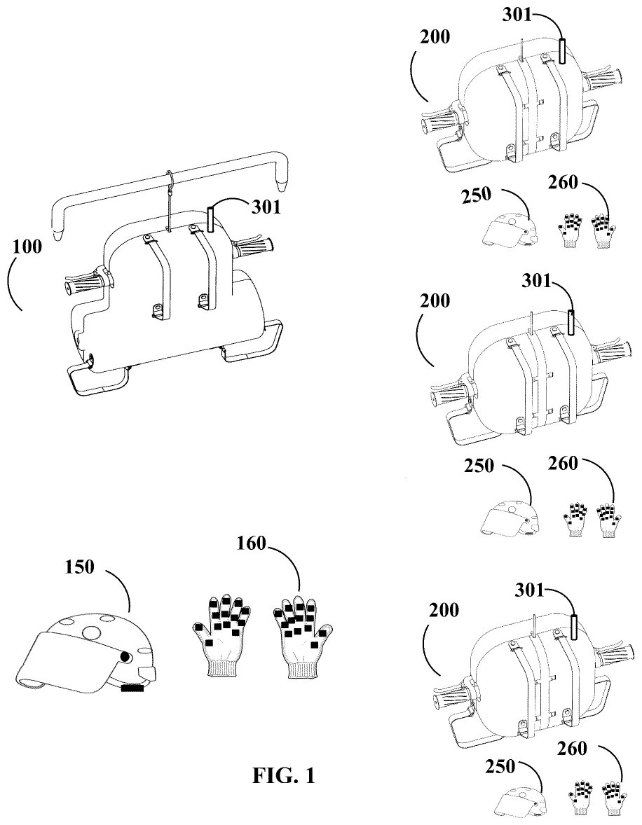

Referring to FIG. 1, the perspective view of a set of devices used for escaping from high-rise buildings or high-level locations includes a first escape device 100, a safety helmet 150, high-strength friction gloves 160, an intercom answering machine 301, and multiple second escape devices 200. The multiple-second escape devices have an intercom answering machine 301, a safety helmet 250, and high-strength friction gloves 260.

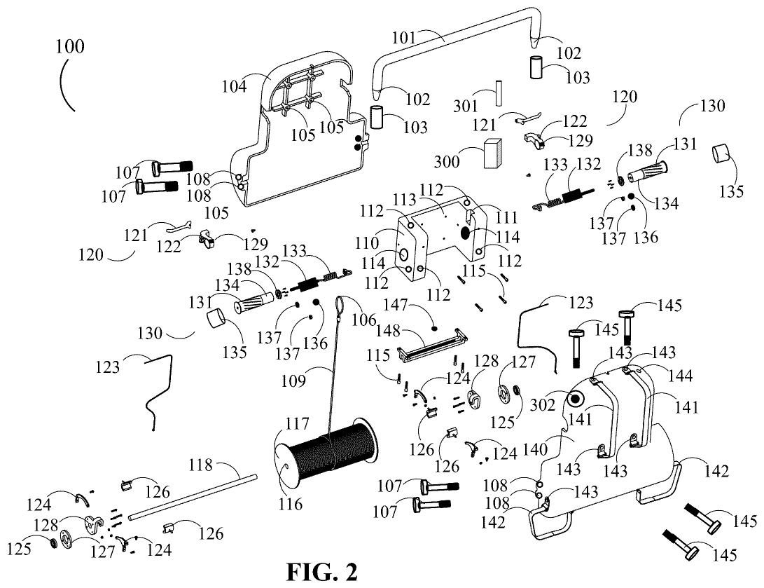

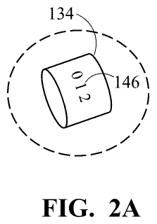

As shown in FIG. 2, the exploded view details the structure of the first escape device 100, including the fixed rod 101 and the cable 109. The upper part has a support structure 110, the spring regulator 139, and the hand brakes 121A and 121B. The lower part comprises the cable winding bracket 117 and the guide device. The front case 104 and back case 140 have two leg trips and two shoulder strips. The fixed rod 101 with conical fixed cones 102 at both ends hangs the cable 109 through the top end ring structure 106. The fixed cone protective sleeve 103 covers the conical fixed cone 102 under normal conditions to prevent the conical fixed cone 102 from causing damage to objects and personnel.

The support structure 110 is the connection center of all functional units in the first escape device. The front case 104 and the rear case 140 fasten with the main support structure 110 through screws 115 and threaded bolts 145. Among them, the shoulder straps 141, and the leg fixing straps 142 on the rear case are screwed and fixed with the threaded holes 112 on the main support structure 110 through the fixing holes 143 on the rear case by bolts 145 so that the first escapee can firmly keep with the first device 100 through the shoulder straps 141 and the leg fixing straps 142. The front case fastens with the threaded holes 105 on the inner side and the threaded holes 113 on the main support structure 110 through screws 115. The intercom answering machine 302's manual wire switch is installed on the upper left of the rear case. The intercom answering machine also has a voice-activated switch and a wireless start switch. The antenna 301 passes through hole 144 and screws with the intercom answering machine 300. The cable 109 is an additional antenna for the intercom answering machine 300. The groove 111 on the main support structure 110 is used to place the intercom answering machine 300. The threaded hole 114 on the main support structure 110 allows the thread 133 on the spring regulator 139 to screw. By rotating the left and right handle 131, the pair of parallel tensions of the spring 133 through the hook adjust and control the moving of cable 109; as a result, the weight of the escapee and the first escape device is balanced as needed to regulate the gravity acceleration generated by the escapee and the first escape device during the descent process. One spring regulator 139 comprises a handle 131 with threaded portion 132, a spring 133 with a hook, and a number marking ring 134. The spring 133 and the handle 131 fasten via a flange 138, a bearing 136, and a fixing nut 137. Such structure allows the spring 133 to remain stationary without rotating when the left and right handles 131 are rotated clockwise or counterclockwise to tighten or relax the spring. The Arabic numerals 146 marked on the number marking ring 134 are used as the helmet basis. The marking number ring 134 is fixed on the handle 131 and rotates synchronously with the handle 131. The hook on the left and right spring 133 opens, allowing the cable to enter when zero aligns with scale line 129 on the hand brake fixing frame 122.

The left-hand brake 121A and the right-hand brake 121B regulate the release speed of the cable 109 and control the escapee's descent speed. The left-hand or right-hand brake comprises a hand brake handle 121, a fixing frame 122, a brake line 123, a bracket 124, a brake shoe 126, and a brake shoe fixing bracket 128. The brake shoe 126 directly controls the rotating speed of the shaft 118 through the hand brake 121, thereby regulating the release speed of the cable 109. The hand brakes 121A and 121B are the second type of regulator that controls the descent speed. The scale line 129 on the hand brake fixing frame 122 is used to identify the number on the number marking ring 134 on the spring regulator. The scale line 129 on the fixing frame 122 cooperates with the marking digital ring 134 to provide the most intuitive adjustment positioning for the spring regulator. If the hand brake and spring regulator cannot control the descent speed due to any fault, the gloves 160 with high-strength friction material (see FIG. 6) can control the descent speed by holding the cable 109 with both hands. The high-strength friction gloves 160 are the third configuration for controlling the descent speed.

The lower part of the first escaping device is mainly used to house and release cable 109. The Bracket 117 with a hole 116 is used for cable winding, storage, and release. The shaft 118 passes through hole 116 and is engaged with the second bearing 125 fixed on flange 127. The flange 127 is fixed by the threaded bolt 107 through holes 108 on the left and right sides of the front and rear cases so that the cable winding bracket 117 is suspended in the front and rear cases. The length of cable 109 and the size of the cable winding bracket 117 mainly depend on the height of the floor where the owner of the escape device lives. The guide device to prevent the cable from winding during the release process comprises the first bearing sliding groove 130 and the first bearing 120 fixed to the first bearing sliding groove on cable 109.

FIG. 2A is an enlarged view of the digital marking ring 134. The Arabic numerals are 0 to 9, wherein the position of 0 indicates that the cable can enter the hooks carried by the two springs 133. The position of 1 indicates that the two hooks are closed, locking the entered cable inside the spring hooks. The numbers after 2 suggest that the spring regulator 139 can use elastic force to balance a certain amount of the first escaping person's and the first device's weight. The pair of spring regulators allow the first scaping person to descend at a safe weight and controllable speed, avoiding the potential injury from gravity acceleration. When the spring tension is greater than or equal to the weight of the escapee and the first escape device, the descent speed is equal to zero. The escapee can use his hands and feet to cross various unpredictable obstacles by regulating the descent speed. The first escapee should never forget that while using the first escape device to escape, the essential life escape channel is also established for other people who need to escape.

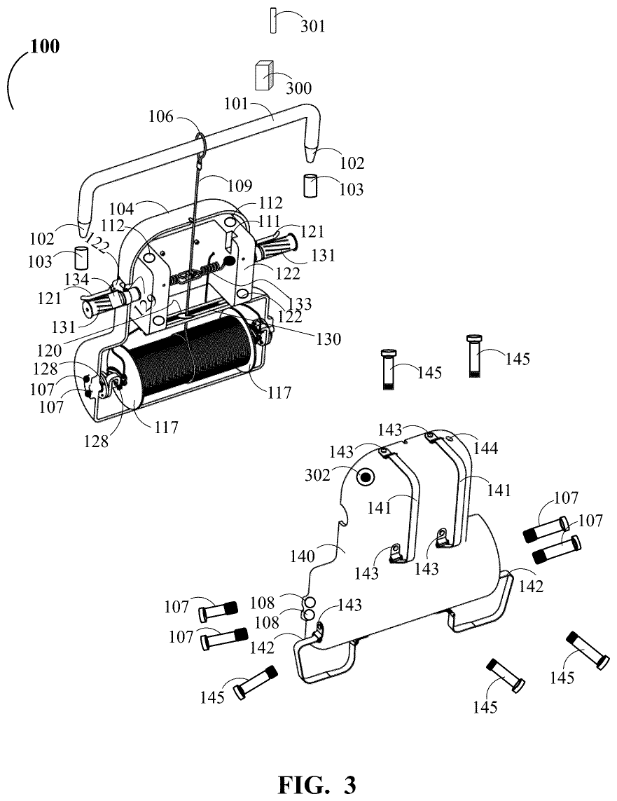

FIG. 3 is a composite diagram of the first escape device 100, separate from the rear case 140. The fixed rod 101 hangs the first escape device 100 through the annular structure 106 at the top end of the cable 109. Conical fixing cones 102 at both ends of fixed rod 101 are used to fasten with the building or other structures where the escapee is located. The left-hand brake handle 121A and the right-hand brake 121B fasten with the fixing frame 122 for regulating the descending speed. The brake shoe 126 is directly used to control the rotation speed of the long shaft 118 to maintain the release speed of the cable. The combination of the scale line 129 on the fixing frame and the digital marking ring 134 makes the use of the spring regulator more convenient and reliable. The spring adjuster 139 is screwed with the threaded hole 114 on the main support structure 110 via the thread portion 132 on the handle 131. The hook on the spring 133 is used to pull cable 109 to both sides so that the tension of the spring can balance the weight of the escapee and the first escape device so that the escapee can control the gravity acceleration. When the Arabic numeral zero on the digital marking ring 134 aligns with the scale line 129, cable 109 can enter the hook on the spring 133 so that the spring adjuster can adjust the tension of the spring 133 on the steel cable through the threaded movement of the thread 132 and the threaded hole 114. The cable 109 can be released from the steel cable winding bracket 117 through a guide device composed of a first bearing sliding groove 130 and a first bearing 120 sleeved on the steel cable 109 to prevent the steel cable from being entangled during the release process. When the hand brake adjusts the steel cable release speed, the guide device can effectively prevent the steel cable 109 from being entangled. The winding bracket 117 of the steel cable 109 passes through the through tube 116 on bracket 117, the center tube on the flange 119, and the second bearing 125 via the long axis 118, and the flange 119 is finally screwed with the threaded holes 108 on the front and rear shells via the bolts 107 so that the winding bracket 117 is suspended. The steel cable 109 is released as required by the weight or gravity of the escapee and the first escape device. The rear shell 140, the shoulder straps 141, and the leg fixing straps 142 are screwed and fixed with the threaded holes 112 on the main support structure 110 via the bolts 145 via the threaded holes 143.

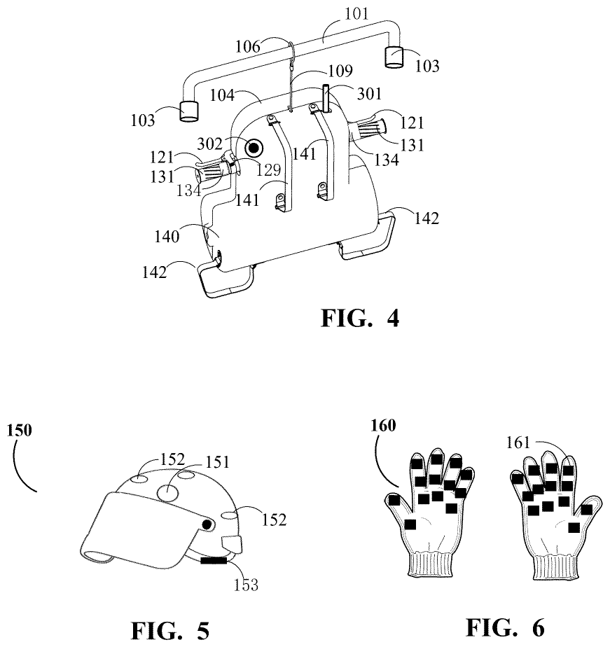

Because of the progress of modern human life, humans are familiar with and use various types of backpack straps, bicycles, and mountaineering tools from childhood to adulthood. They can already understand the use of the first escape device from its appearance. As shown in FIG. 4, the front view of the first escape device gives an intuitive understanding of the method used by the first escape device 100 at a glance. The fixed cone 102, on both ends of the fixed rod 101, is covered with a fixed cone protective cover 103 to prevent the fixed cone from damaging the surrounding environment and personnel. When using the first escape device 100, the escapee should use shoulder straps 141 and leg straps 142 to hang the first escape device 100 on the front chest and legs. Use both hands to hold handle 131 of the spring adjuster to make the first escaping device and the first escapee one. Then, use the hand brake to control the descending speed in real time as needed. The manual switch 302 of the intercom answering machine 300 can facilitate the escapee's communication with other escapees and acceptance of the command and dispatch of ground rescue personnel. When people cannot escape and are separated from the escape equipment, a voice-activated switch can be active instead. The intercom answering machine 300 allows the trapped people to contact and call for help from the ground rescue center without directly touching the intercom answering machine on the escape device. The disaster relief center can also wirelessly activate the intercom answering machine 300 to allow the trapped people to contact the ground rescue center. The wirelessly activated intercom answering machine microphone allows the trapped person to call for help remotely or the search and rescue center to locate the trapped person in real-time and effectively explore life information, including heartbeat, breathing, and weak or extremely weak calls for help through the activated intercom answering machine. The intercom answering machine is equipped with a battery or a rechargeable battery. The intercom answering machine 300 can be automatically charged by wire or wireless. The intercom answering machine 300 can have GPS, Beidou, and Zifeng chips, which allow the search and rescue center and the search and rescue personnel to locate the trapped person in real-time. In contrast, the Zifeng chip temporarily establishes a communication network through drones or other devices to inform the real-time situation of the trapped person. The steel cable 109 can become a wired antenna by linked to the receiving and transmitting device, providing an additional antenna for the intercom answering machine 300 so that the trapped person can communicate more easily with the search and rescue center. The rescue center can use the intercom answering machine to count and understand the survivors, the trapped persons, and the specific positions of the trapped persons in real time to coordinate rescue and post-disaster management.

The safety helmet 150 is a crucial safety equipment during the disaster and safe escape process. As shown in FIG. 5, the safety helmet 150 can prevent the falling debris from harming the escapee. The safety helmet 150 has warning lights 151 with a warning function. The flashing warning light helps the escapees maintain a safe distance from each other and prevents the escapees from colliding with each other and causing personal injury. The lighting lamp 152 is provided to the escapee to observe the surrounding environment through the lighting lamp when escaping at night, avoid various obstacles from harming the escapee, and choose the best safe escape route. The battery 153 is the power source of the lighting lamp and the warning light. The battery can be charged by a charger wired or wirelessly.

The gloves 160 (FIG. 6) configured with the first escape device have a fireproof function to protect the escapee during the escape. The escapee can safely operate and use the first escape device under the protection of protective gloves. If the two-hand brakes 120 and the two spring regulators 130 malfunction and cannot control the descent speed, a high-strength friction material 161 can use the gloves to hold the cable 109 tightly and thus control the descent speed.

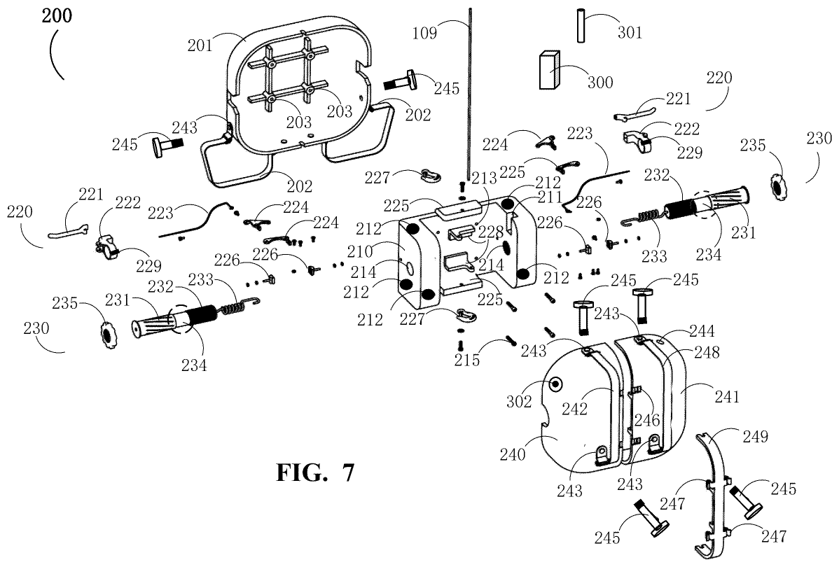

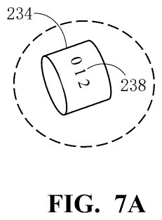

FIG. 7 is an exploded view of the second escape device, 200. Unlike the first escape device, the second escape device does not have its escape cable. Still, it uses cable 109 or other rope-like objects, such as ropes, steel bars, or steel pipes, released by the first escapee from the first device to escape from the dangerous environment. Therefore, the second escape device, 200, is more compact and lightweight, and the internal structure is adjusted accordingly. The front case 201 of the second device has two-leg fixing belt 202, and the double-leg fixing belt 202 is screwed and fixed with the threaded hole 212 on the main support structure 210 by bolts 245 through the upper and lower through holes 243 of the double-leg fixing belt. The front shell 201 is screwed with the main support structure 210 via threads 237. The rear shell comprises a left rear shell 240, a right rear shell 241, and a movable protective plate 249. Among them, the position of the movable middle plate 249 is the channel for cable 109 to enter the second escape device 200. The left rear plate 240 and the right rear plate 241 are screwed with the threaded holes 212 on the main support structure 210 by bolts 245 through the upper and lower fixing holes 243 of the left and right shoulder straps 242 and 248. The buckle 247 on the movable middle plate 249 locks with the slots 246 on the left rear case 240 and the proper rear plate case 241.

The two sets of hand brakes are composed of a hand brake handle 221, a fixing frame 222, a brake wire 223, a brake wire bracket 224, a brake shoe 226, and a brake shoe bracket 228 for fixing the brake shoe bracket 224. After the steel cable 109 enters the second device 200, it will remain in the two brake shoes 226 so that the brake shoes 226 can adjust the steel cable 109 and control the descending speed at any time by the degree of gripping the hand brake handle 221. The spring regulator on the second escape device 200 is composed of a handle 231, a threaded portion 232, a spring 233 with a hook, a number mark ring 234, and a washer 235. When the Arabic numeral zero on the number mark ring 234 aligns with the scale line 229, the steel cable 109 can enter the hook carried by the spring 233. When the Arabic numeral one aligns with the scale line 229, cable 109 is locked by the hooks on spring 133 so that the spring regulator can adjust the parallel tension of spring 233 on the steel cable 109 through the thread movement of the thread 232 and the threaded hole 114 through the hook, thereby balancing the weight of the second escapee and the second escape device according to actual needs, to control the gravity acceleration generated during the descent.

To ensure that the steel cable 109 always retains in the hooks on the spring 233 and the brake shoe 226, the second escape device is added with a pair of steel cable safety locks 227. The steel cable 109 first enters the steel cable safety lock 227 and then enters the hook on the spring 133 and the brake shoe 226 of the hand brake. The steel cable safety lock 227 is screwed with the fixing plate 225 fixed above and below the main support structure 210 by bolts. The fixing groove 211 on the main support structure 210 houses the intercom on machine 300. The through-hole 244 is a screwing channel for the antenna 301 and the intercom answering machine 300.

FIG. 7A is an enlarged view of the digital marking ring 134. The Arabic numerals are 0 to 9, wherein the position of 0 indicates that the cable can enter the hooks carried by the two springs 133. The position of 1 indicates that the two hooks are closed, locking the entered cable inside the spring hooks. The numbers after 2 suggest that the spring regulator 139 can use elastic force to balance a certain amount of the first escaping person's and the first device's weight. The pair of spring regulators allow the first scaping person to descend at a safe weight and controllable speed, avoiding the potential injury from gravity acceleration. When the spring tension is greater than or equal to the weight of the escapee and the first escape device, the descent speed is equal to zero. The escapee can use his hands and feet to cross various unpredictable obstacles by regulating the descent speed. The first escapee should never forget that while using the first escape device to escape, the essential life escape channel is for other people who need to escape.

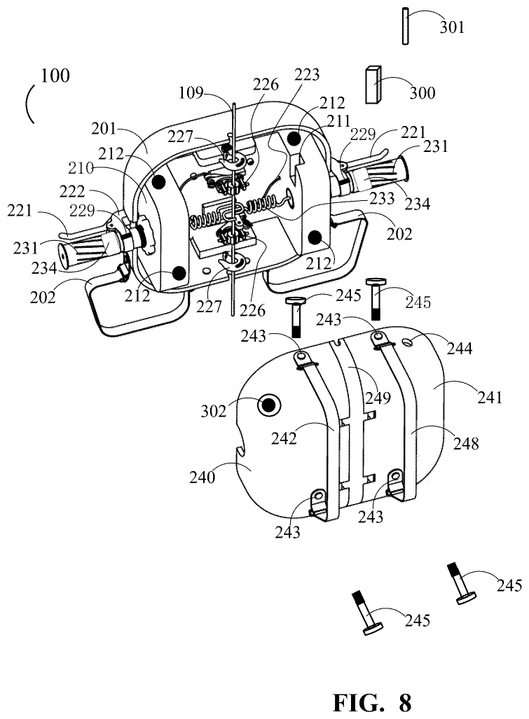

FIG. 8 is a composite diagram of the second escape device 200 after the left rear shell 240, the proper rear shell 241, and the movable protective plate 249 are separated. By rotating the handle 231 clockwise or counterclockwise, the spring 233 adjusts to pull the cable 109 in parallel to both sides and the tension of the spring balances the weight of the escapee and the second escape device 200 so that the escapee can control the gravity acceleration. The hand brake handle 221 fastens with the fixed frame 222, which provides convenience for adjusting the descent speed. The closing of the brake shoe 226 is adjusted by the hand brake handle 221 through the brake line 223, thereby controlling the cable 109 and changing the descent speed of the escapee and the first escape device 200 so that the escapee is always in a safe state during the descent process. The reasonable combination of the scale line 229 on the fixed frame and the digital marking ring 234 makes using the spring regulator more convenient and reliable. The spring adjuster 239 screws with the threaded hole 214 on the main support structure 210 via thread 232. When the Arabic numeral zero on the digital marking ring 234 aligns with the scale line 229, the steel cable 109 can enter the hook and brake shoe 226 of the spring 233. The steel cable safety lock 227 can ensure that the steel cable entering the hook and brake shoe 226 of the spring 233 always stays in the hook and brake shoes so that the spring adjuster can adjust the descending speed by moving the thread 232 with the internal thread of the threaded hole 214. The left rear shell 240 and the right rear shell 241 are screwed and fixed with the threaded hole 212 on the main support structure 210 by the fixing bolt 245 through the leg strap and shoulder strap fixing hole 243. The movable protective plate 249 buckles with the card slot 246 on the left and right shells through the buckle 247.

Placement slot 211 on the main support structure 210 houses the intercom answering machine 300. The antenna 301 fastens to the intercom answering machine 300 through hole 244 above the right rear shell 241. The Switch 302, arranged above the left case 240, is a wired answering switch for the intercom answering machine. When the personnel cannot escape and are separated from the escape equipment, a voice-activated switch can be used instead, which allows the trapped personnel to contact and call for help with the ground rescue center without directly contacting the intercom answering machine on the escape device. The ground rescue center can also activate the intercom answering switch through a wireless signal so that the trapped personnel can contact and call for help from the ground rescue center. The wirelessly activated intercom answering machine microphone allows the trapped personnel to call for help remotely or the rescue center to locate the trapped personnel in real-time and effectively explore life information through the activated intercom answering machine, including heartbeat, breathing, and weak or very weak calls for help. The intercom transponder 300 can have GPS and Beidou positioning chips, which allow the search and rescue center and rescue personnel to locate the trapped people in real-time.

In contrast, the Zigbee chip can establish a temporary communication network through drones or other devices to inform the trapped people of their real-time situation. The cable 109 can be connected to the receiving and transmitting devices to become a wired antenna, providing an additional antenna for the intercom transponder 300, making it easier for the trapped people to communicate with the search and rescue center. A battery powers the intercom transponder, and the wireless charger can charge the battery as required.

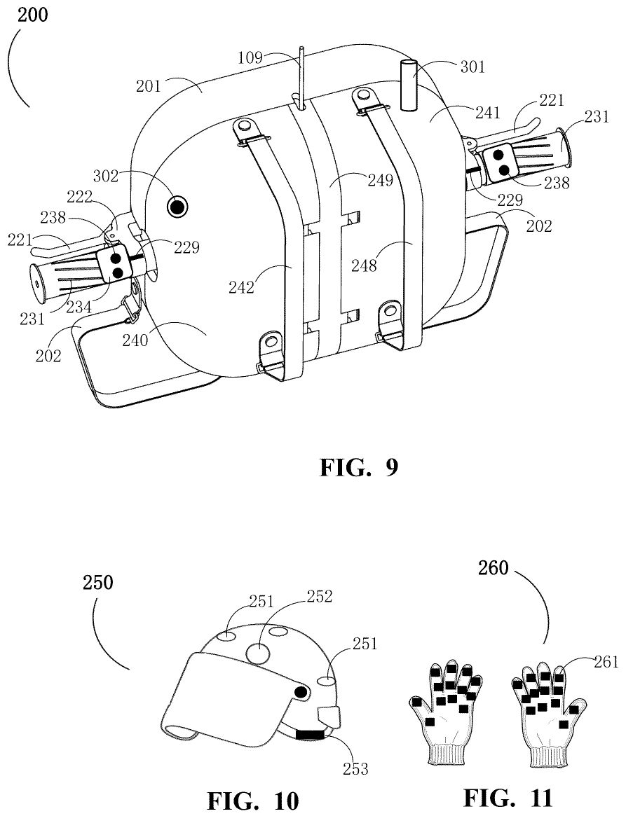

Due to the progress of modern life, humans have been familiar with and used backpack straps, various types of bicycles, and mountaineering tools from childhood to adulthood. They can already know the use of the second escape device from its appearance. FIG. 9 is a three-dimensional front view of the second escape device, which provides an intuitive understanding of the method used by the second escape device 200 at a glance. When using the second escape device 200 to escape, first remove the movable protective plate 249 from the rear shell, and push the steel cable 109 into the hook of the spring 233, the brake shoe 266 and the steel cable safety lock 227, and buckle the movable protective plate 249. Use the shoulder and leg fixing straps to hang the second escape device 200 in front of the chest and above the legs. Use both hands to hold the handle 231 of the spring adjuster so that the escapee can keep the second escape device 200 together. Use the hand brake handle 221 to adjust the descending speed in real-time. The manual switch 302 of the intercom answering machine can facilitate the communication between the escapee and other escapees and the command and dispatch of the ground rescue personnel. The voice-controlled switch allows the trapped person to contact and call for help from the ground search and rescue center without directly contacting the intercom answering machine 300 on the second escape device 200. The search and rescue center can also wirelessly turn on the intercom answering machine 300. The GPS and Beidou positioning chips equipped with the intercom answering machine allow the search and rescue center and the rescue personnel to locate the trapped person in real time, while the Zigbee chip allows the second escape device 200 to establish a communication channel with a drone or other temporarily established network communication equipment to inform the trapped person of the real-time situation. The steel cable 109 becomes the antenna of the intercom answering machine through a wireless link with the receiving and transmitting device of the intercom answering machine, making it easier for the trapped person to communicate with the search and rescue center. The intercom answering machine can automatically charge using a wire and wireless charger. The second escape device is universal. In any dangerous environment, as long as there is a steel cable, rope, or steel pipe that is similar to the steel cable released by the first escape device 100, people can use the second device to escape from a high building, a high place, an aerial cableway or a high mountain. Therefore, people on the same floor, height, structure, or mountain can use the steel cable or a steel cable-like structure nearby to escape.

The safety helmet 250 is a necessary piece of equipment for the second escape device. As shown in FIG. 5, the safety helmet 250 is an effective safety protection equipment when a disaster occurs. The helmet can also effectively prevent the escapees from being harmed by falling debris during the escape process. The safety helmet 250 has various colored warning lights 251 with a warning function, which helps the escapees maintain a safe distance through the flashing warning light and prevents the escapees from colliding with each other and causing personal injury. The lighting lamp 252 is provided to the escapees so they can observe the surrounding environment through the lighting lamp when escaping at night, avoid various obstacles from harming the escapees, and choose the best safe escape route.

The configured high-strength friction gloves 260 (FIG. 6) have a fireproof function to protect the escapee during escape. The escapee can safely operate and use the first escape device under the protection of protective gloves. In case the hand brake and the spring regulator are unable to adjust the descent speed, the force-applying part of the gloves is coated with a high-strength friction material 261 so that the escapee can use the gloves to hold the steel cable 109 tightly, thereby controlling the descent speed.

The above is only a relatively preferred specific implementation of the present invention. The present invention is not limited to it. Any technician familiar with the technical field may make various changes or related modifications within the scope of the claims. Still, any person who makes an equivalent replacement or change based on the technical solution and its improved concept of the present invention should be included in the protection scope of the present invention.

We claim:

1. A set of escape devices for escaping from high-rise buildings or high-level locations, comprising:
at least one first escape device with a cable, a helmet with a lighting lamp and different colored warning lamps, at least one pair of high-strength friction fireproof gloves, and a metal rod with two ends bent for hanging the escape cable;
a plurality of second escape devices,
wherein each of the second devices includes a helmet with a lighting lamp and different colored warning lamps and at least one pair of high-strength friction fireproof gloves; and
an intercom answering machine configured on the first escape device and the plurality of second escape devices;
wherein the first escape device having: an upper part, a lower part, and a front case and back cases with two leg trips and two shoulder strips;
wherein the upper part of the first escape device consisting of:
a support structure with a plurality of threatened holes and a groove for housing the walkie-talkie,
at least one left-hand spring regulator and at least one right-hand spring regulator regulating the descent weight and descent speed,
at least one left-hand brake or/and at least one right-hand brake are used to control the release speed of the cable, wherein the lower part of the first escape device is used for the storage and release of the cable, comprising:
a cable,
wherein the cable is an additional standard antenna of the intercom answering machine equipped with the first escape device and the second escape device; a bracket with a central penetrable hole housing and fixing the shaft used to wind the cable, a pair of bearings, a pair of flanges, a shaft, a guide device for regulating the release of the cable and preventing the cable from disorderly winding, and a various screws and bolts; wherein one of the at least one of the plurality of second escape devices, having: a support structure with a plurality of threatened holes and a groove for housing the intercom answering machine,
at least one left-hand spring regulator and at least one right-hand spring regulator are used to regulate the descent weight and descent speed,
at least one left-hand brake or/and at least one right-hand brake are used to control the descent speed, at least one safety lock, a various screws and bolts, and a front case and rear case;
wherein the rear case composes of: a left rear case, a right rear case, and a movable protective plate sandwiched between the left and suitable cases;
wherein the left rear case has one leg strip and one shoulder strip fastened with the support structure via bolts, and the proper rear case has one leg strip and one shoulder strip fastened with the support structure via bolts;
wherein the intercom answering machine having:
a manual switch, a voice-activated switch, and
a wireless starting-able answering switch to turn on the trapped intercom answering machine;
wherein the wireless starting-able switch is activated by the search and rescue center at a special frequency, and turns on the trapped intercom answering machine by amplifying the power signal; wherein the wirelessly activated intercom answering machine microphone allows the trapped person to call for help;
wherein the intercom answering machine microphone allows the search and rescue center to locate the trapped person in real-time to explore life information, including heartbeat, breathing, and weak or extremely weak calls for help, through the activated intercom answering machine;
wherein the intercom answering machine is powered by a battery or a rechargeable battery which is able to be charged via wired or wireless.

2. The high-rise escape devices of claim 1, wherein the left-hand spring regulator and the right-hand spring regulator in the first and second escape devices having:
a pair of spring with a hook,
a pair of thread adjustment handles, and
a digital marking ring with Arabic numerals on each adjustment handles.

3. The high-rise escape devices of claim 2, wherein each spring with a hook fixed to the inner end of the adjustment handle through a first nut, a bearing, a flange, and a second nut.

4. The high-rise escape devices of claim 2, wherein the threaded adjustable handle is jointly screwed with the threaded holes on the supporting structure to adjust the spring tension.

5. The high-rise escape devices of claim 2, wherein the Arabic numerals are composed of 0 to 9.

6. The high-rise escape devices of claim 1, wherein the left handbrake or/and right handbrake in the first device comprising:
a handle,
a fixing frame with a scale line,
a wire,
a moveable bracket for fixing the brake shoe,
a supporting structure to hold the bracket, and
a pair of semicircular brake shoes for controlling the long axis rotation speed.

7. The high-rise escape devices of claim 1, wherein the left handbrake or/and right handbrake in the second device comprising:
a handle,
a fixing frame with a scale line,
a wire,
a pair fixed brackets,
a moveable bracket for fixing the brake shoe,
a pair of semicircular brake shoes for holding the cable.

8. The high-rise escape devices of claim 1, wherein the intercom answering machine can join temporary disaster relief or drone networks to receive and transfer information.

9. A set of escape devices for escaping from high-rise buildings or high-level locations, comprising: a plurality of escape devices,
at least one cable or cable-like structure or rope or tube or tube-like structure; wherein one of the at least one of the pluralities escape devices having: a support structure with a plurality of threatened holes and a groove for housing the intercom answering machine, at least one pair of spring regulators, at least one left-hand brake or/and at least one right-hand brake, at least one safety lock, a various screws and bolts, a front case, a left rear case with a leg strip and a shoulder strip, a right rear case with a leg strip and a shoulder strip, a movable protective plate sandwiched between the left and suitable cases, a helmet with lighting lamp and different colored warning lamps, a pair of high-strength friction fireproof gloves, and an intercom answering machine.
